(19) United States
(12) Patent Application Publication
(10) Pub. No.: US 2012/0150440 A1
(43) Pub. Date: Jun. 14, 2012

(54) POSITIONING APPARATUS, POSITIONING METHOD, AND STORAGE MEDIUM FOR MEASURING POSITION USING BOTH AUTONOMOUS NAVIGATION AND GPS

(75) Inventor: Masao SAMBONGI, Tokyo (JP)

(73) Assignee: CASIO COMPUTER CO., LTD., Tokyo (JP)

(21) Appl. No.: 13/314,482

(22) Filed: Dec. 8, 2011

(30) Foreign Application Priority Data
Dec. 8, 2010 (JP) 2010-273127

(51) Int. Cl. G01C 21/00

(52) U.S. Cl. 701/472

(57) ABSTRACT

A positioning apparatus performs two-phased correction in the case where continuous relative position data are acquired by autonomous-navigation positioning unit without acquiring absolute positions, and after that, absolute position data are acquired corresponding to a plurality of points using positioning satellites. In the first phase, correction is performed on continuous relative position data corresponding to a period in which absolute position data is acquired, by associating such continuous relative position data with the acquired absolute position data. In the second phase, correction is preformed on relative position data acquired without absolute positions, by using the parameter identical to that of the first correction.

### BACKGROUND OF THE INVENTION

1. Field of the Invention

The present invention relates to a positioning apparatus, a positioning method, and a storage medium for acquiring continuous position data corresponding to positions on a moving route.

2. Description of Related Art

In the past, an autonomous-navigation positioning apparatus has been known. The apparatus acquires continuous position data corresponding to positions on a moving route by continuously measuring the moving direction and moving distance of a moving body with an autonomous navigation sensor and by adding relative position data, which is composed of the measured moving direction and moving distance, to absolute position data corresponding to a starting point.

Japanese Unexamined Patent Application Publication No. 11-230772 discloses a technique of correcting position data acquired through autonomous navigation positioning using positioning satellites.

Japanese Unexamined Patent Application Publication No. 2008-232771 discloses another technique of correcting an autonomous navigation sensor through positioning using positioning satellites.

### SUMMARY OF THE INVENTION

An object of the present invention is to provide a positioning apparatus, a positioning method, and a storage medium for converting relative position data, which is continuously obtained from a starting point, into accurate and continuous absolute position data, even if absolute position data of the positioning apparatus cannot directly be acquired in a period from the starting point.

According to a first aspect of the present invention, there is provided a positioning apparatus including: a first positioning unit that acquires absolute position data by receiving a signal from a positioning satellite at predetermined time intervals to measure a current position of the positioning apparatus; a second positioning unit that acquires relative position data by continuously detecting a movement and a traveling direction of the positioning apparatus; a route data acquisition unit that acquires a series of route data corresponding to a moving route of the positioning apparatus based on the absolute position data and the relative position data; a route data correction unit that corrects apart of the series of route data corresponding to a positioning period including a plurality of positioning timings at the predetermined time intervals by the first positioning unit, based on absolute position data acquired at the plurality of positioning timings; a first determination unit that determines whether a first plurality of absolute position data are acquired in a first positioning period; and a second determination unit that determines whether a second plurality of absolute position data are acquired in a second positioning period that does not overlap the first positioning period, wherein the route data correction unit includes: a parameter generation unit that generates a correction parameter for correcting a second part of the series of route data corresponding to the second positioning period based on the second plurality of absolute position data when the first determination unit determines that the first plurality of absolute position data are not acquired in the first positioning period and the second determination unit determines that the second plurality of absolute position data are acquired in the second positioning period, and a parameter correction unit that corrects a first part of the series of route data corresponding to the first positioning period based on the correction parameter generated by the parameter generation unit.

According to a second aspect of the present invention, there is provided a positioning method including: (a) acquiring absolute position data by receiving a signal from a positioning satellite at predetermined time intervals to measure a current position; (b) acquiring relative position data by continuously detecting a movement and a traveling direction; (c) acquiring a series of route data corresponding to a moving route based on the absolute position data and the relative position data; (d) correcting a part of the series of route data corresponding to a positioning period including a plurality of positioning timings at the predetermined time intervals by step (a), based on absolute position data acquired at the plurality of positioning timings; (e) determining whether a first plurality of absolute position data are acquired in a first positioning period; and (f) determining whether a second plurality of absolute position data are acquired in a second positioning period that does not overlap the first positioning period, wherein step (d) includes: (g) generating a correction parameter for correcting a second part of the series of route data corresponding to the second positioning period based on the second plurality of absolute position data when step (e) determines that the first plurality of absolute position data are not acquired in the first positioning period and step (f) determines that the second plurality of absolute position data are acquired in the second positioning period, and (h) correcting a first part of the series of route data corresponding to the first positioning period based on the correction parameter generated by step (g).

According to a third aspect of the present invention, there is provided a computer readable storage medium having recorded thereon a computer program to control a computer controlling a first positioning unit that acquires absolute position data by receiving a signal from a positioning satellite at predetermined time intervals to measure a current position of a positioning apparatus, and a second positioning unit that acquires relative position data by continuously detecting a movement and a traveling direction of the positioning apparatus, wherein the program controls the computer to function as : a route data acquisition unit that acquires a series of route data corresponding to a moving route of the positioning apparatus based on the absolute position data and the relative position data; a route data correction unit that corrects a part of the series of route data corresponding to a positioning period including a plurality of positioning timings at the predetermined time intervals by the first positioning unit, based on absolute position data acquired at the plurality of positioning timings; a first determination unit that determines whether a first plurality of absolute position data are acquired in a first positioning period; and a second determination unit that determines whether a second plurality of absolute position data are acquired in a second positioning period that does not overlap the first positioning period, wherein the route data correction unit includes: a parameter generation unit that generates a correction parameter for correcting a second part of the series of route data corresponding to the second positioning period based on the second plurality of absolute position data when the first determination unit determines that the first plurality of absolute position data are not acquired in the first positioning period and the second determination unit determines that the second plurality of absolute position data are acquired in the second positioning period, and a parameter correction unit that corrects a first part of the series of route data corresponding to the first positioning period based on the correction parameter generated by the parameter generation unit.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a block diagram illustrating the overall configuration of a positioning apparatus according to an embodiment of the present invention;

FIG. 2A illustrates a locus representing moving route data acquired in the first step of an operation of the positioning apparatus;

FIG. 2B illustrates a locus representing moving route data acquired in the second step of the operation of the positioning apparatus;

FIG. 2C illustrates a locus representing moving route data acquired in the third step of the operation of the positioning apparatus;

FIG. 2D illustrates a locus representing moving route data acquired in the fourth step of the operation of the positioning apparatus;

FIG. 3 illustrates an expansion/contraction ratio and a rotation angle in similarity transformation;

FIG. 4 is a flow chart illustrating a control process of positioning control performed by a CPU;

FIG. 5 is a flow chart illustrating the detailed steps of moving-route-data correction performed in Step S17 in FIG. 4;

FIG. 6A illustrates a locus representing uncorrected moving route data in a modification of the moving-route-data correction;

FIG. 6B illustrates absolute position data acquired through GPS positioning and a corresponding locus in the modification of the moving-route-data correction;

FIG. 6C illustrates a locus representing corrected moving route data in the modification of the moving-route-data correction; and

FIG. 6D illustrates a portion (a point corresponding to timing T6) of FIG. 6C, which portion is enlarged.

### DESCRIPTION OF THE PREFERRED EMBODIMENTS

An embodiment of the present invention will be described with reference to the accompanying drawings.

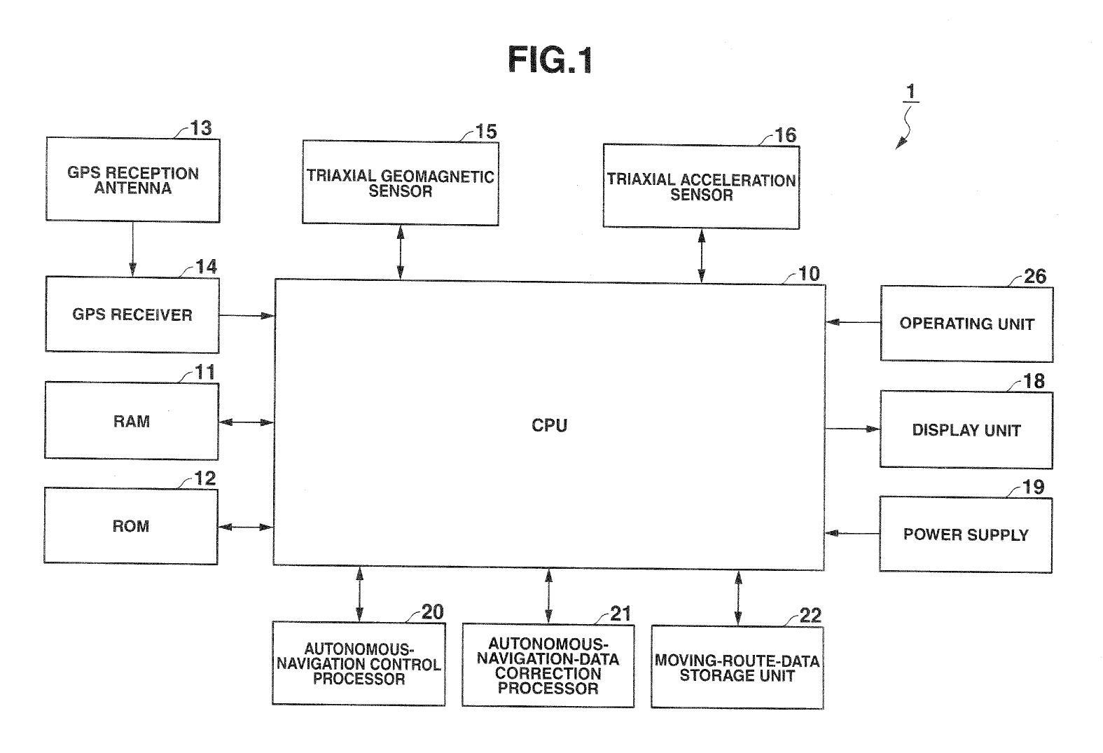

FIG. 1 is a block diagram illustrating the overall configuration of a positioning apparatus according to an embodiment of the present invention.

The positioning apparatus 1 of this embodiment records moving route data which contains position data corresponding to each point on a travelling path, through measuring positions while moving along the travelling path.

As illustrated in FIG. 1, the positioning apparatus 1 includes a central processing unit (CPU) 10 comprehensively controlling the entire apparatus; a RAM 11 providing a work space for the CPU 10; a ROM 12 holding control programs to be executed by the CPU 10 and control data used by the control programs; a global positioning system (GPS) reception antenna 13 and a GPS receiver 14 receiving signal data from GPS satellites; a triaxial geomagnetic sensor 15 and a triaxial acceleration sensor 16, which are autonomous navigation sensors; a display unit 18 displaying various types of information and images; a power supply 19 supplying an operating voltage to each unit; an operating unit 26 receiving operation instructions from an external unit; an autonomous-navigation control processor 20 performing autonomous navigation positioning on the basis of data obtained by the autonomous navigation sensors 15 and 16; an autonomous-navigation-data correction processor 21 correcting moving route data acquired by the autonomous-navigation control processor 20; and a moving-route-data storage unit 22 accumulating moving route data.

The GPS receiver 14 receives signal data from the GPS satellites via the GPS reception antenna 13 in response to an operation instruction from the CPU 10 and demodulates the received signal data.

The CPU 10 performs predetermined positioning based on the signal data from the GPS satellites to calculate absolute position data representing a current position.

The GPS reception antenna 13, the GPS receiver 14, and the positioning function of the CPU 10 constitute a first positioning unit.

The triaxial geomagnetic sensor 15, for example, includes a magnetoresistive element and can detect the three-dimensional directions of geomagnetism.

The triaxial acceleration sensor 16 detects acceleration in each of the three axial directions.

The autonomous-navigation control processor 20 is a computing unit that assists the CPU 10.

The autonomous-navigation control processor 20 acquires measured data obtained by the triaxial geomagnetic sensor 15 and the triaxial acceleration sensor 16 at a predetermined sampling cycle via the CPU 10.

The autonomous-navigation control processor 20 calculates the moving direction and moving distance of the positioning apparatus 1 on the basis of the measured data.

The autonomous-navigation control processor 20 adds the relative position data, which contains the moving direction and moving distance with respect to the absolute position calculated as above, to the absolute position data sent from the CPU 10. Thereby, the autonomous-navigation control processor 20 calculates absolute position data based on a result of autonomous navigation positioning and to send the computed absolute position data to the CPU 10.

The triaxial geomagnetic sensor 15, the triaxial acceleration sensor 16, and the autonomous-navigation control processor 20 constitute a second positioning unit.

The autonomous navigation sensors (triaxial geomagnetic sensor 15 and triaxial acceleration sensor 16) and the autonomous-navigation control processor 20 of the positioning apparatus of this embodiment enable autonomous navigation positioning for a walking body.

Specifically, the autonomous-navigation control processor 20 measures the number of walking steps on the basis of intense vibration in the vertical direction included in the output from the triaxial acceleration sensor 16 and multiplies the number of walking steps by pre-set stride data to calculate the moving distance.

In addition, the autonomous-navigation control processor 20 analyzes large changes in acceleration in the front-back direction of the walking body and small changes in acceleration in the traverse direction included in the output from the triaxial acceleration sensor 16.

The autonomous-navigation control processor 20 then determines which direction the walking body is travelling in with respect to the triaxial acceleration sensor 16, on the basis of the analytical result.

The autonomous-navigation control processor 20 also determines the azimuth of the measured moving direction on the basis of the direction of geomagnetism detected by the triaxial geomagnetic sensor 15 and the direction of gravity detected by the triaxial acceleration sensor 16.

Autonomous navigation positioning contains, for example, certain errors in the stride data and certain offset errors in the output of the triaxial geomagnetic sensor 15.

Thus, the result of autonomous navigation positioning contains a certain proportion of error due to both the moving distance and moving direction.

The autonomous-navigation-data correction processor 21 is a computing unit that assists the CPU 10.

The autonomous-navigation-data correction processor 21 corrects the moving route data, which is acquired by the autonomous-navigation control processor 20 and stored in the moving-route-data storage unit 22, on the basis of absolute position data acquired through intermittent GPS positioning to obtain more accurate moving route data.

If the moving route data stored in the moving-route-data storage unit 22 contains position data represented by relative coordinates not associated with absolute coordinates, the autonomous-navigation-data correction processor 21 also performs correction to associate the relative coordinates of the moving route data with the absolute coordinates on the basis of absolute position data acquired through intermittent GPS positioning.

Details of such correction will be described below.

The moving-route-data storage unit 22 includes, for example, a non-volatile memory.

The moving-route-data storage unit 22 holds moving route data containing time-sequential position data acquired by the autonomous-navigation control processor 20 and moving route data corrected by the autonomous-navigation-data correction processor 21.

The moving route data also contains, for example, data on a serial number representing the order of acquisition, data on a positioning time for each position data, relative coordinate flags indicating whether each position data is represented as absolute coordinates or relative coordinates, and correction flags indicating whether each position data has been corrected.

The ROM 12 holds a positioning control program for acquiring moving route data, which represents the moving route, by combining continuous autonomous navigation positioning and intermittent GPS positioning.

The ROM 12 also holds a moving-route-data correction program executed by the autonomous-navigation-data correction processor 21.

The CPU 10 and the positioning control program constitute a route data acquisition unit.

The autonomous-navigation-data correction processor 21 and the moving-route-data correction program constitute a route data correction unit.

The CPU 10 and the autonomous-navigation-data correction processor 21 constitute a computer, which execute programs.

The programs are stored in the ROM 12, or alternatively, may be stored in, for example, a portable storage medium, such as an optical disc, and a non-volatile memory, such as flash memory, which are readable by the CPU 10 via a data reading device.

Such programs may also be downloaded to the positioning apparatus 1 on a carrier wave transmitted via a communication line.

[Outline of Operation]

Positioning control by the positioning apparatus 1, which has the configuration described above, will be described below.

The following is the positioning control performed when a user operates the positioning apparatus 1 at a location where radio waves from the GPS satellites cannot be received and, after that, carries the positioning apparatus 1 to a location where the radio waves can be received.

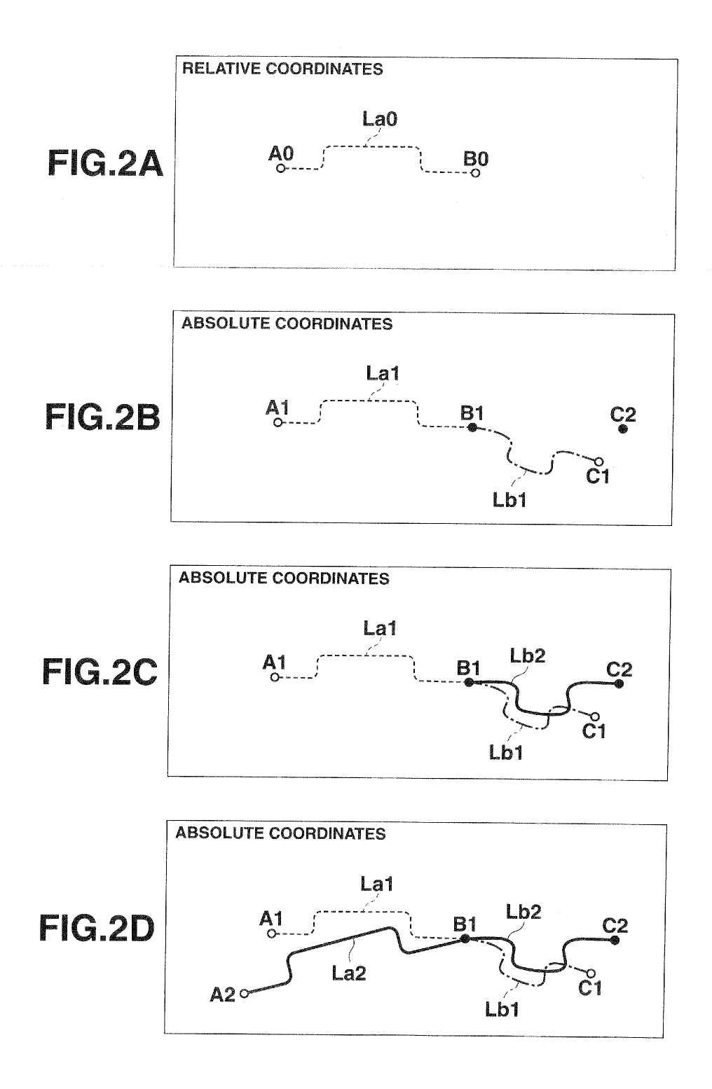

FIGS. 2A to 2D illustrate the flow of the positioning control performed under such a situation.

FIGS. 2A to 2D illustrate the loci representing moving route data acquired in first to fourth steps, respectively, of the positioning control process.

As illustrated in FIG. 2A, if GPS positioning is not available at the beginning of the positioning control process, the positioning apparatus 1 continuously measures relative positions from an unknown starting position by autonomous navigation positioning to acquire moving route data represented by relative coordinates.

The relative coordinates of the moving route data are acquired, for example, by assigning imaginary absolute position data (for example, latitude of 90 degrees and longitude of 0 degrees) to the starting position AO and adding the relative position data measured through autonomous navigation positioning to the position data at the starting position A0.

The locus La0 in FIG. 2A is obtained by connecting the relative coordinates of the moving route data in a chronological order.

Then, as illustrated in FIG. 2B, when the positioning apparatus 1 moves to a location where radio waves from the GPS satellites can be received, GPS positioning is performed to acquire absolute position data of point B1, immediately after the positioning apparatus 1 moves to the location where the radio wave is receivable or after a predetermined time.

Even after the positioning apparatus 1 has moved to a location where radio waves from the GPS satellites can be received, autonomous navigation positioning is continuously performed.

After acquisition of the absolute position data at point B1 through GPS positioning, the positioning apparatus 1 associates the relative coordinates, which represent the moving route data (locus La0) acquired earlier, with the absolute positions in such a way that the association is performed in the order from the endpoint to the starting point of the locus. Thereby, the positioning apparatus 1 acquires moving route data (locus La1) represented by absolute coordinates.

Specifically, the positioning apparatus 1 calculates the difference between the position data of the end point (point B0) of the moving route data (locus La0) represented by relative coordinates, and the absolute position data at point B1 acquired through GPS positioning, which is the same point as point B0. Then, the positioning apparatus 1 adds the difference to every data in the moving route data (locus La0) represented by relative coordinates. Thereby, the positioning apparatus 1 acquires the moving route data (locus La1) represented by absolute coordinates.

The positioning apparatus 1 may convert the relative coordinates to absolute coordinates upon acquiring absolute position data at point B1 or at any other timing.

With the positioning apparatus 1 in this embodiment, as illustrated in FIG. 2C, the conversion is performed when absolute position data of points B1 and C2 are intermittently acquired through GPS positioning.

Through autonomous navigation positioning performed after point B1, where absolute position data has been acquired, moving route data represented by absolute coordinates is calculated by adding the measured relative position data to the absolute position data of point B1.

The locus Lb1 in FIG. 2B is obtained by connecting the absolute coordinates of moving route data in a chronological order.

Subsequently, the positioning apparatus 1 performs GPS positioning upon receiving intermittent signal data from the GPS satellites (upon arriving at point C1 in FIG. 2B).

At this point, the position data acquired through autonomous navigation positioning corresponds to point C1, while the absolute position data acquired through GPS positioning corresponds to point C2.

In autonomous navigation positioning, errors are cumulated as the positioning apparatus 1 moves. Hence, the position data corresponding to point C1 does not match with that of point C2.

When accurate GPS positioning is performed intermittently, the positioning apparatus 1 in this embodiment corrects the moving route data (loci Lb1 and La1) acquired earlier, using accurate absolute position data at point C2.

As illustrated in FIG. 2C, the positioning apparatus 1 corrects the moving route data (locus Lb1) between a plurality of points where GPS positioning has been performed.

Through such correction, the position data corresponding to the starting point and the endpoint in the uncorrected moving route data (locus Lb1) are matched with the absolute position data corresponding to points B1 and C1, respectively, acquired through GPS positioning.

Specifically, the correction includes similarity transformation for uniformly expanding/contracting and rotating the locus Lb1, which corresponds to the moving route data acquired in the period between point B1 and point C1; and defines the continuous absolute position data corresponding to the locus Lb2, on which similarity transformation has been performed, as corrected moving route data.

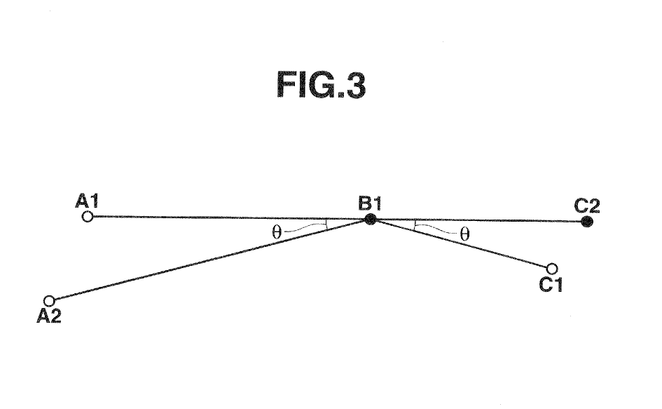

FIG. 3 illustrates the expansion/contraction ratio and the rotation angles in similarity transformation.

In the actual correction process, the positioning apparatus 1 performs transformation through the following correction calculation process.

That is, the positioning apparatus 1 calculates the rotation angle θ (=ΔC1,B1,C2) and the expansion/contraction ratio of line segment B1-C2 to line segment B1-C1 on the basis of position data of points B1, C1, and C2 in FIG. 3.

The positioning apparatus 1 then performs correction such that position data corresponding to each point in the uncorrected moving route data (locus Lb1) are converted by expanding or contracting the line segment from point B1 to each point at the calculated expansion/contraction ratio, and by rotating each expanded or contracted line segment around point B1 by an angle θ.

Through such a correction process, the positioning apparatus 1 can satisfactorily remove errors that are uniformly included in the moving distance and moving direction obtained through autonomous navigation positioning.

As illustrated in FIG. 2D, the positioning apparatus 1 subsequently corrects the moving route data (locus La1) acquired before performing GPS positioning for the first time.

In this correction process, the positioning apparatus 1 performs similarity transformation on the locus La1, which corresponds to uncorrected moving route data acquired in the period between point A1 and point B1, so as to uniformly expand or contract and rotate the locus La1 around the end point B1 using the expansion/contraction ratio and angle θ used in the similarity transformation performed earlier.

In this correction process, the continuous absolute position data corresponding to the locus La2, on which the similarity transformation has been performed, is defined as the corrected moving route data.

Since the expansion/contraction ratio and angle θ used in the similarity transformation of the previously-performed correction are used in this correction process, as illustrated in FIG. 3, the position data of the starting point A1 in the uncorrected moving route data (locus La1) and the position data of the starting point A2 in the corrected moving route data (locus La2) have the following relationship:

the expansion/contraction ratio of line segment B1-A2 to line segment B1-A1 is the same as the expansion/contraction ratio of line segment B1-C2 to line segment B1-C1; and

the rotation angle ΔA1,B1,A2 is the same as the rotation angle ΔC1,B1,C2.

In this way, correction is performed on the moving route data (locus La1) acquired before the first GPS positioning.

Specifically, in the case where errors are uniformly included in the moving distance and moving direction obtained through autonomous navigation positioning, the errors can be satisfactorily removed because it is presumed that the ratio of errors is the same before and after GPS positioning.

Then, while the user who carries the positioning apparatus 1 is continuing to move, the same process as that performed when the positioning apparatus 1 moves from point B1 is repeated.

That is, moving route data is acquired through continuous autonomous navigation positioning with reference to the absolute position data acquired through intermittent GPS positioning.

Then, the positioning apparatus 1 repeats GPS positioning after a predetermined time elapses since the last GPS positioning, and corrects the moving route data corresponding to the time between the previous GPS positioning and the current GPS positioning.

Such a process is repeated to record accurate moving route data corresponding to the moving route.

[Control Process]

A control process of positioning control for the above-described operation will be described in detail below.

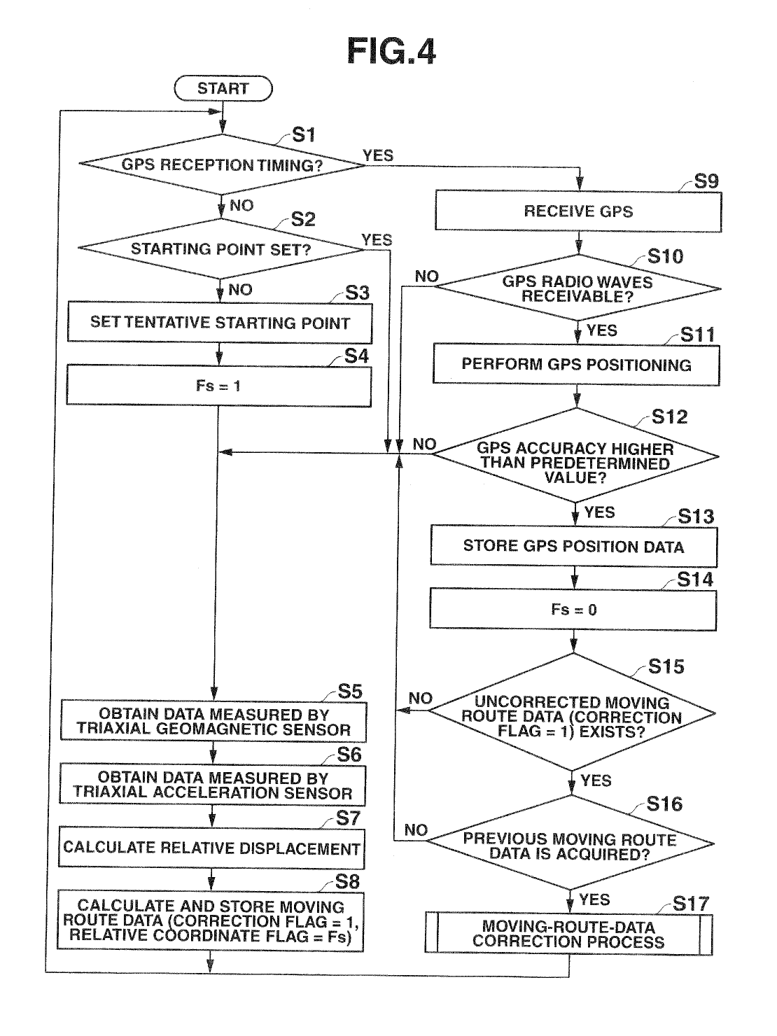

FIG. 4 is a flow chart illustrating the positioning control executed by the CPU 10.

In Step 51 in the flow chart of FIG. 4, the CPU 10 determines whether it is a timing for performing intermittent GPS positioning.

In Steps S2 to S4, the CPU 10 sets position data for a tentative starting point if the absolute position of the starting point is unknown at the beginning of autonomous navigation positioning.

The CPU 10 then assigns the value “1” to the flag variable Fs, which indicates the use of relative coordinates. This indicates that the relative position data acquired through the subsequent autonomous navigation positioning is represented by relative coordinates.

Steps S5 to S8 perform one set of autonomous navigation positioning.

Specifically, the CPU 10 samples measured data obtained by the geomagnetic sensor 15 and the triaxial acceleration sensor 16 (Steps S5 and S6).

The CPU 10 sends the sampled data to the autonomous-navigation control processor 20 which then calculates the relative positions and the current absolute position (Step S7).

The CPU 10 receives the position data calculated by the autonomous-navigation control processor 20, prepares moving route data corresponding to one point by adding serial-number data, time data, a correction flag, and a relative coordinate flag to the received position data, and writes the moving route data in the moving-route-data storage unit 22 (Step S8).

Since the written moving route data is uncorrected, the value “1” is assigned to the correction flag, and the value of variable Fs is assigned to the relative coordinate flag.

Steps S1 and S5 to S8 are repeated in loops for continuous autonomous navigation positioning, except for an intermittent timing for GPS positioning.

As a result, moving route data is accumulated in the moving-route-data storage unit 22.

If the starting point is unknown at the beginning of positioning control due to unavailable GPS positioning, a tentative starting point is set in Step S3.

Autonomous navigation positioning is then continuously performed, and moving route data containing positional data represented by relative coordinates is accumulated in the moving-route-data storage unit 22.

Steps S9 to S17 perform GPS positioning and processing associated therewith.

Specifically, the CPU 10 operates the GPS receiver 14 to start a receiving process (Step S9).

Then, the CPU 10 checks whether signal data from the GPS satellites are received (Step S10).

If the CPU 10 determines that signal data are not received, the CPU 10 interrupts GPS positioning and starts autonomous navigation positioning in Step S5.

If the CPU 10 determines that signal data are received, the CPU 10 performs GPS positioning on the basis of the received signal data to compute absolute position data (Step S11).

Subsequently, the CPU 10 acquires precision information of the result of the GPS positioning based on the received signal data and determines whether the precision is higher than a predetermined value (Step S12).

Such precision information may contain, for example, a dilution-of-precision (DOP) value or GNSS pseudorange error statistics (GST).

If the precision is not higher than the predetermined value as a result of determination, the CPU 10 discards the results of GPS positioning and starts the autonomous navigation positioning process in Step S5.

If the precision is higher than the predetermined value, the CPU 10 stores the absolute position data acquired as a result of positioning in, for example, the RAM 11 or the moving-route-data storage unit 22 (Step S13).

The CPU 10 assigns the value “0” to the variable Fs indicating the use of relative coordinates because position data represented by absolute coordinates will be acquired through subsequent autonomous navigation positioning (Step S14).

Then, the CPU 10 determines whether uncorrected moving route data (i.e., data in which the value “1” is assigned to the correction flag) is stored in the moving-route-data storage unit 22 (Step S15).

If uncorrected moving route data is stored, the CPU 10 determines whether absolute position data is acquired through previously-performed GPS positioning (Step S16).

This is because the correction requires absolute position data corresponding to a plurality of points.

If the previous absolute position data has been acquired, the CPU 10 sends a command to the autonomous-navigation-data correction processor 21 to start the correction (Step S17).

After the correction process starts, the CPU 10 returns the process to Step S1.

If either of the determination result of Step S15 or S16 is NO, the CPU 10 does not start correction process but starts autonomous navigation positioning in Step S5.

As described above, intermittent GPS positioning is performed through Steps S9 to S17.

If highly precise absolute position data is acquired, autonomous navigation positioning is performed by using this absolute position data as the absolute position data of a reference point.

Furthermore, if absolute position data with high precision are acquired at a plurality of points, the moving-route-data correction is performed.

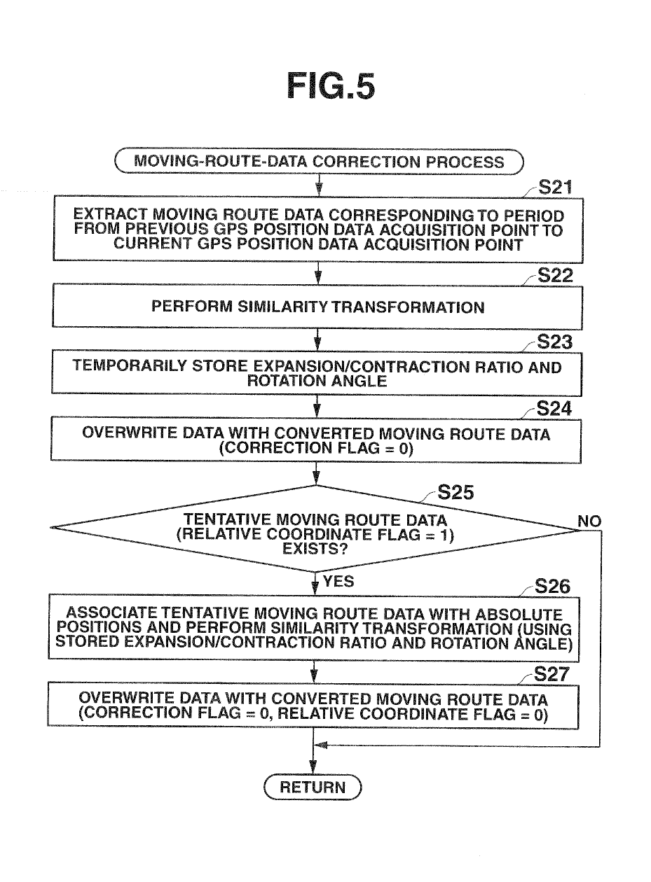

FIG. 5 is a detailed flow chart illustrating the moving-route-data correction performed in Step S17 in FIG. 4.

Upon start of the moving-route-data correction, the autonomous-navigation-data correction processor 21 extracts, from the moving-route-data storage unit 22, moving route data corresponding to the path from the point at which absolute position data was acquired through the previous GPS positioning to the point at which the absolute position data is acquired through the current GPS positioning (Step S21).

With reference to FIG. 2B, for example, the absolute position data of point B1 is the data acquired through the previous GPS positioning, and the absolute position data of point C2 is the data acquired through the current GPS positioning. In this case, each of the moving route data represented by the locus Lb1 is extracted.

Subsequently, the autonomous-navigation-data correction processor 21 performs correction by performing similarity transformation to match both ends of the locus corresponding to the extracted moving route data with the absolute positions acquired through GPS positioning (Step S22: first and second correction units).

In the example of FIG. 2C, the moving-route-data correction is equivalent to the process of acquiring the corrected locus Lb2 based on the uncorrected locus Lb1.

The autonomous-navigation-data correction processor 21 temporarily stores the expansion/contraction ratio and rotation angle for similarity transformation in, for example, the RAM 11 (Step S23).

Then, the autonomous-navigation-data correction processor 21 overwrites data in the moving-route-data storage unit 22 with the corrected moving route data for each point (Step S24).

Since the position data are corrected, the autonomous-navigation-data correction processor 21 assigns the value “0” to the correction flag.

Subsequently, the autonomous-navigation-data correction processor 21 determines whether tentative moving route data represented by relative coordinates, i.e., data in which the value “1” is assigned to the relative coordinate flag, is stored in the moving-route-data storage unit 22 (Step S25).

If no such data is stored, the autonomous-navigation-data correction processor 21 ends the moving-route-data correction.

In contrast, if the data whose relative coordinate flag is “1” is stored, the autonomous-navigation-data correction processor 21 associates the tentative moving route data represented by relative coordinates with the absolute positions, and performs the correction using similarity transformation on the locus (Step S26: a parameter correction unit).

The association of the tentative moving route data with absolute positions is a process of converting the locus La0 in FIG. 2A to the locus La1 in FIG. 2B.

The correction using similarity transformation is a process of converting the locus La1 to the locus La1 in FIG. 2D.

The correction using similarity transformation is performed using the extraction/contraction ratio and the rotation angle temporarily stored in Step S23.

After correcting the tentative moving route data, the autonomous-navigation-data correction processor 21 overwrites data in the moving-route-data storage unit 22 with corrected moving route data of each point (Step S27).

At this time, since the position data have been corrected, the autonomous-navigation-data correction processor 21 assigns the value “0” to the correction flag.

Since the position data have been converted to absolute coordinate values, the autonomous-navigation-data correction processor 21 assigns the value “0” to the relative coordinate flag.

After overwriting data with the moving route data, the autonomous-navigation-data correction processor 21 finishes the moving-route-data correction.

The correction process described above with reference to FIGS. 2A to 2D is achieved through such moving-route-data correction.

[Modification]

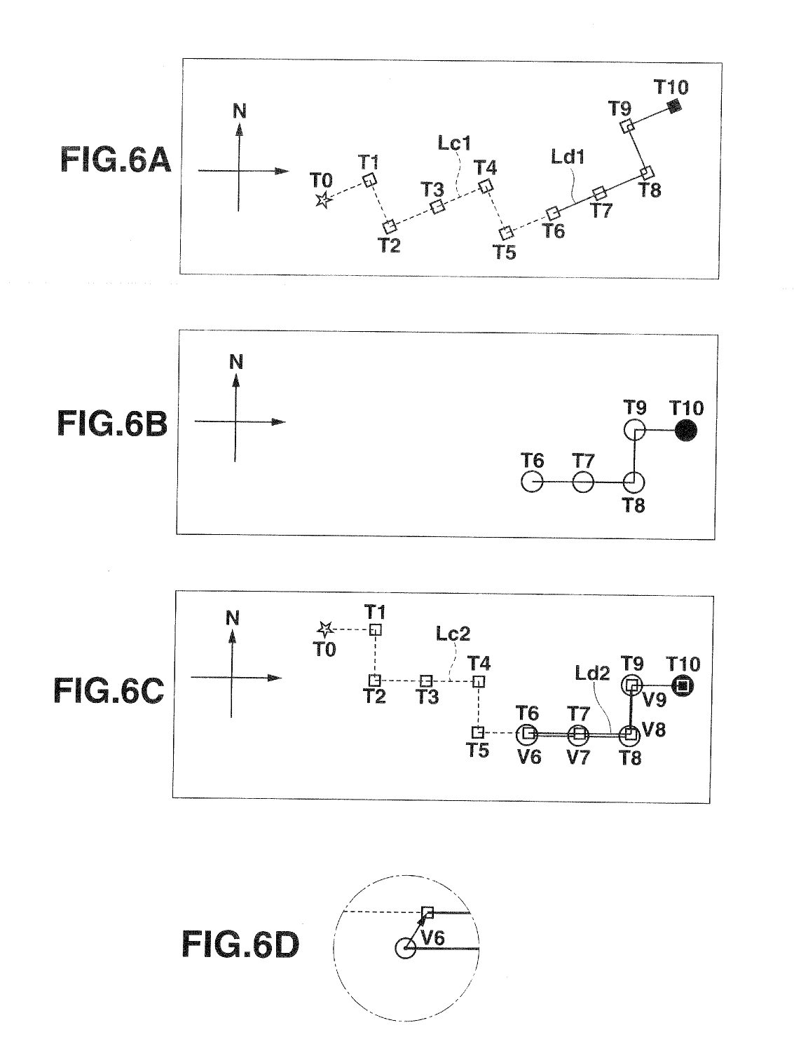

FIGS. 6A to FIG. 6C illustrate a modification of the correction of moving route data.

FIG. 6A illustrates the locus representing uncorrected moving route data.

FIG. 6B illustrates the locus representing absolute position data acquired through GPS positioning.

FIG. 6C illustrates the locus representing corrected moving route data.

FIG. 6D illustrates a portion of FIG. 6C, which portion is enlarged.

The correction in this modification is performed in a situation where absolute position data corresponding to more than two points (points at timings T6 to T10) are acquired through GPS positioning. The correction includes the following two corrections: one is a correction of moving route data corresponding to the locus between these points and; and the other is a correction of moving route data acquired with no absolute position prior to these points known.

In FIG. 6A, the locus Lc1 represented by the dotted line is a locus representing moving route data acquired through autonomous navigation positioning performed with the absolute positions unknown.

The locus Ld1 represented by the solid line is a locus representing moving route data acquired through autonomous navigation positioning after absolute position data is acquired.

In FIGS. 6B and 6C, the center of each circle represents the absolute position acquired through GPS positioning.

In FIGS. 6A to 6C, reference characters T0 to T10 represent the timings at which positioning are performed.

As illustrated in FIGS. 6A and 6B, the positioning apparatus 1 performs continuous autonomous navigation positioning; meanwhile, when absolute position data are acquired through GPS positioning at the respective points at timings T6 to T10, the autonomous-navigation-data correction processor 21 corrects the moving route data (locus Ld1) corresponding to the locus between the points as described below.

As in FIG. 6C, illustrating the corrected locus Ld2, the autonomous-navigation-data correction processor 21 fixes the endpoint of the locus Ld1 to a point corresponding to the absolute position data acquired by the GPS.

The autonomous-navigation-data correction processor 21 then performs similarity transformation by uniformly expanding or contracting and rotating the locus Ld1 such that the position data of the locus Ld1 at timings T6 to T9 approximate the absolute position data acquired through GPS positioning.

Even after performing such similarity transformation, the position data of the corrected locus Ld2 at timings T6 to T9 acquired through GPS positioning (corresponding to the center point of each square in FIG. 6C) and the absolute position data acquired at timings T6 to T9 through GPS positioning (corresponding to the center point of each circle in FIG. 6C) do not necessarily match completely.

Thus, as illustrated in the partially enlarged view in FIG. 6D, the autonomous-navigation-data correction processor 21 calculates an expansion/contraction ratio and a rotation angle that make difference vectors V6 to V9 small as a whole, each of the difference vectors representing the difference between position data and the corresponding absolute position data.

Specifically, the autonomous-navigation-data correction processor 21 calculates an expansion/contraction ratio and a rotation angle that minimizes the average of the square sum of the difference vectors V6 to V9 (equivalent to the mean squared error of the position data at timings T6 to T9 and the corresponding absolute position data).

To reduce the load of calculating the expansion/contraction ratio and the rotation angle, only the rotation angle may be determined by minimizing average of square sum of the difference vectors V6 to V9, for example. In this case, the expansion/contraction ratio may be determined in another way, e.g., by matching both ends of the locus Ld2 with the absolute position data corresponding to timings T6 and T10.

In contrast, only the expansion/contraction ratio may be determined by minimizing average of square sum of the difference vectors V6 to V9, for example. In this case, the rotation angle may be determined in another way, e.g., by matching both ends of the locus Ld2 with the absolute position data corresponding to timings T6 and T10.

Then, the autonomous-navigation-data correction processor 21 corrects each position data in the moving route data (locus Ld1) between the plurality of points so that the corrected position data equals the position data of the locus Ld2, which has undergone similarity transformation using the calculated expansion/contraction ratio and rotation angle.

Subsequently, the autonomous-navigation-data correction processor 21 corrects the moving route data (locus Lc1) acquired with the absolute positions unknown.

The moving route data (locus Lc1) is converted from relative coordinates to absolute coordinates in the order from the end point to the starting point of the locus, on the basis of the absolute position data at timing T6, in advance.

Then, when similarity transformation is performed, which uses a expansion/contraction ratio and a rotation angle identical to those used in the similarity transformation performed earlier on the locus Ld1, the autonomous-navigation-data correction processor 21 corrects each position data in the moving route data (locus Lc1) such that the position data of the locus Lc2 after undergoing similarity transformation is the corrected position data.

The rotation center of similarity transformation is set at the point corresponding to timing T10, which is the same as that used in similarity transformation performed earlier on the locus Ld1.

Such correction can appropriately correct the moving route data corresponding to a locus between a plurality of points acquired through autonomous navigation positioning, and the moving route data acquired earlier in a state that the absolute positions are unknown, in the case where the absolute position data corresponding to more than two points are acquired through GPS positioning.

If absolute position data with an accuracy lower than a predetermined threshold are acquired through GPS positioning at a plurality of points before absolute position data with an accuracy higher than the predetermined threshold is acquired, for example, the correction process in accordance with this modification can used so as to appropriately correct the moving route data using a plurality of absolute position data having the accuracy lower than the predetermined threshold.

In the correction process described above, if highly accurate absolute position data is acquired at timing T8 in FIGS. 6A to 6C, similarity transformation of loci Ld1 and Lc1 may be performed with the absolute position at timing T8 being the rotation center.

As described above, in accordance with the positioning apparatus 1 and the positioning method according to this embodiment, moving route data represented by relative coordinates acquired through autonomous navigation positioning with the absolute position unknown is converted to absolute coordinates if absolute position data are acquired later at a plurality of points. Then, the moving route data is corrected using the absolute position data corresponding to the plurality of points.

Accordingly, the positioning apparatus 1 can record accurate moving route data for a moving route where continuous autonomous navigation positioning is performed with the absolute positions unknown.

With the positioning apparatus 1 and the positioning method according to this embodiment, similarity transformation is performed on moving route data corresponding to the locus between a plurality of points whose absolute position data are acquired. The similarity transformation is performed in such a way that both ends of the uncorrected locus match with the acquired absolute position data.

Then, the positioning apparatus 1 corrects the position data based on the locus after undergoing similarity transformation; then, performs similarity transformation, which uses an expansion/contraction ratio and a rotation angle identical to those used in the similarity transformation performed above, on the moving route data acquired with the absolute positions unknown such that the endpoint of the locus of the moving route data matches the corresponding absolute positions; and corrects the position data based on the locus after undergoing similarity transformation to acquire corrected moving route data.

Accordingly, the positioning apparatus 1 can appropriately remove errors, which are uniformly included in the autonomous navigation positioning, from moving route data acquired without obtaining a starting point, and thereby, can acquire accurate moving route data.

In accordance with the positioning apparatus 1 and the positioning method according to this embodiment, if absolute position data corresponding to more than two points are acquired through GPS positioning before correcting the moving route data, at least one of the expansion/contraction ratio and rotation angle for similarity transformation can be determined in the following manner: that is, the position data of points corresponding to the moving route data approximate the corresponding absolute position data. More specifically, the mean squared error of the difference between the position data of each point and the corresponding absolute position data is minimized.

Hence, moving route data can be corrected to accurate values even in the case described above.

The present invention is not limited to the embodiment described above, and can include various modifications.

For example, in the embodiment of the present invention described above, a tentative starting point is set and moving route data represented by relative coordinates is prepared in the case where autonomous navigation positioning is performed without obtaining the absolute positions. Instead of relative coordinates, data of continuous relative positions measured through autonomous navigation positioning may be recorded.

In such a case, when absolute position data is acquired through next GPS positioning, the data of continuous relative positions can be converted to data of continuous position data represented by absolute coordinates by associating the data of relative positions with the data of absolute positions in the order from the end point to the starting point of the locus.

In the embodiment of the present invention described above, moving route data is corrected by uniformly expanding or contracting and rotating a locus of the moving route data such that the position data corresponding to acquisition timings of the absolute position data on the locus matches with absolute position data acquired through GPS positioning. Instead, various different correction methods may be employed.

For example, in the case where error is accumulated at a constant rate in accordance with the moving distance, the present invention may employ the following correction: an error per unit distance is determined as a correction parameter by dividing the error measured at a current GPS positioning point by the moving distance along the moving route from the previous GPS positioning point; then, an error is removed based on the presumption that the error is included in the moving route data in accordance with the moving distance from the previous GPS positioning point.

In this way, correction can be performed, using the correction parameter described above, on moving route data acquired through autonomous navigation positioning without obtaining absolute positions.

In the embodiment of the present invention described above, the first positioning unit uses GPS satellites. Instead, the first positioning unit may use another type of positioning satellite in a similar manner.

Further, in the present invention, the second positioning unit performs positioning of a walking body using the geomagnetic sensor 15 and the triaxial acceleration sensor 16. Instead, various modifications can be employed. For example, positioning may be performed by measuring the moving distance and moving direction of a vehicle through detection of the wheel rotation and gyro sensor rotation angle, respectively.

The detailed configuration and methods described in the embodiment may be changed appropriately without departing from the scope of the invention.

The entire disclosures of Japanese Patent Application No. 2010-273127 filed on Dec. 8, 2010 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. A positioning apparatus comprising:
a first positioning unit that acquires absolute position data by receiving a signal from a positioning satellite at predetermined time intervals to measure a current position of the positioning apparatus;
a second positioning unit that acquires relative position data by continuously detecting a movement and a traveling direction of the positioning apparatus;
a route data acquisition unit that acquires a series of route data corresponding to a moving route of the positioning apparatus based on the absolute position data and the relative position data;
a route data correction unit that corrects a part of the series of route data corresponding to a positioning period including a plurality of positioning timings at the predetermined time intervals by the first positioning unit, based on absolute position data acquired at the plurality of positioning timings;
a first determination unit that determines whether a first plurality of absolute position data are acquired in a first positioning period; and
a second determination unit that determines whether a second plurality of absolute position data are acquired in a second positioning period that does not overlap the first positioning period,
wherein the route data correction unit includes:
a parameter generation unit that generates a correction parameter for correcting a second part of the series of route data corresponding to the second positioning period based on the second plurality of absolute position data when the first determination unit determines that the first plurality of absolute position data are not acquired in the first positioning period and the second determination unit determines that the second plurality of absolute position data are acquired in the second positioning period, and
a parameter correction unit that corrects a first part of the series of route data corresponding to the first positioning period based on the correction parameter generated by the parameter generation unit.

2. The positioning apparatus according to claim 1, wherein
the first determination unit determines whether first absolute position data are acquired at timings of both ends of the first positioning period,
the second determination unit determines whether second absolute position data are acquired at timings of both ends of the second positioning period,
the route data correction unit further includes:
a first correction unit that performs a similarity transformation by uniformly expanding or contracting and rotating a first locus corresponding the first part of the series of route data, such that both end positions of the first locus match the respective first absolute position data when the first determination unit determines that the first absolute position data are acquired, and
a second correction unit that performs a similarity transformation by uniformly expanding or contracting and rotating a second locus corresponding the second part of the series of route data, such that both end positions of the second locus match the respective second absolute position data when the second determination unit determines that the second absolute position data are acquired,
wherein the parameter generation unit generates an expansion/contraction ratio and a rotation angle to be used in the similarity transformation performed by the second correction unit, as the correction parameter, and
the parameter correction unit corrects the first part of the series of route data based on the correction parameter generated by the parameter generation unit.

3. The positioning apparatus according to claim 2, wherein
the first determination unit determines whether absolute position data are acquired at three or more timings including the timings of the both ends of the first positioning period, and wherein
when the first determination unit determines that the absolute position data are acquired at three or more timings including the timings of the both ends of the first positioning period, the first correction unit determines at least one of the expansion/contraction ratio and the rotation angle to be used in the similarity transformation based on a predetermined condition so as to decrease a difference between each of the absolute position data acquired at the three or more timings and each corresponding position data in the series of route data after the similarity transformation.

4. The positioning apparatus according to claim 3, wherein the first correction unit determines at least one of the expansion/contraction ratio and the rotation angle to be used in the similarity transformation so as to minimize a mean square error between the absolute position data acquired at the three or more timings and the corresponding position data in the series of data after the similarity transformation.

5. A positioning method comprising:
(a) acquiring absolute position data by receiving a signal from a positioning satellite at predetermined time intervals to measure a current position;
(b) acquiring relative position data by continuously detecting a movement and a traveling direction;
(c) acquiring a series of route data corresponding to a moving route based on the absolute position data and the relative position data;
(d) correcting a part of the series of route data corresponding to a positioning period including a plurality of positioning timings at the predetermined time intervals by step (a), based on absolute position data acquired at the plurality of positioning timings;
(e) determining whether a first plurality of absolute position data are acquired in a first positioning period; and
(f) determining whether a second plurality of absolute position data are acquired in a second positioning period that does not overlap the first positioning period, wherein step (d) includes:
(g) generating a correction parameter for correcting a second part of the series of route data corresponding to the second positioning period based on the second plurality of absolute position data when step (e) determines that the first plurality of absolute position data are not acquired in the first positioning period and step (f) determines that the second plurality of absolute position data are acquired in the second positioning period, and
(h) correcting a first part of the series of route data corresponding to the first positioning period based on the correction parameter generated by step (g).

6. The positioning method according to claim 5, wherein step (e) determines whether first absolute position data are acquired at timings of both ends of the first positioning period,
step (f) determines whether second absolute position data are acquired at timings of both ends of the second positioning period,
step (d) further includes:
(i) performing a similarity transformation by uniformly expanding or contracting and rotating a first locus corresponding the first part of the series of route data, such that both end positions of the first locus match the respective first absolute position data when step (e) determines that the first absolute position data are acquired, and
(j) performing a similarity transformation by uniformly expanding or contracting and rotating a second locus corresponding the second part of the series of route data, such that both end positions of the second locus match the respective second absolute position data when step (f) determines that the second absolute position data are acquired,
wherein step (g) generates an expansion/contraction ratio and a rotation angle to be used in the similarity transformation performed by step (j), as the correction parameter, and
step (h) corrects the first part of the series of route data based on the correction parameter generated by step (g).

7. The positioning method according to claim 6, wherein
step (e) determines whether absolute position data are acquired at three or more timings including the timings of the both ends of the first positioning period, and wherein
when step (e) determines that the absolute position data are acquired at three or more timings including the timings of the both ends of the first positioning period, step (i) determines at least one of the expansion/contraction ratio and the rotation angle to be used in the similarity transformation based on a predetermined condition so as to decrease a difference between each of the absolute position data acquired at the three or more timings and each corresponding position data in the series of route data after the similarity transformation.

8. The positioning method according to claim 7, wherein step (i) determines at least one of the expansion/contraction ratio and the rotation angle to be used in the similarity transformation so as to minimize a mean square error between the absolute position data acquired at the three or more timings and the corresponding position data in the series of data after the similarity transformation.

9. A computer readable storage medium having recorded thereon a computer program to control a computer controlling a first positioning unit that acquires absolute position data by receiving a signal from a positioning satellite at predetermined time intervals to measure a current position of a positioning apparatus, and a second positioning unit that acquires relative position data by continuously detecting a movement and a traveling direction of the positioning apparatus, wherein the program controls the computer to function as:
a route data acquisition unit that acquires a series of route data corresponding to a moving route of the positioning apparatus based on the absolute position data and the relative position data;
a route data correction unit that corrects a part of the series of route data corresponding to a positioning period including a plurality of positioning timings at the predetermined time intervals by the first positioning unit, based on absolute position data acquired at the plurality of positioning timings;
a first determination unit that determines whether a first plurality of absolute position data are acquired in a first positioning period; and
a second determination unit that determines whether a second plurality of absolute position data are acquired in a second positioning period that does not overlap the first positioning period,
wherein the route data correction unit includes:
a parameter generation unit that generates a correction parameter for correcting a second part of the series of route data corresponding to the second positioning period based on the second plurality of absolute position data when the first determination unit determines that the first plurality of absolute position data are not acquired in the first positioning period and the second determination unit determines that the second plurality of absolute position data are acquired in the second positioning period, and
a parameter correction unit that corrects a first part of the series of route data corresponding to the first positioning period based on the correction parameter generated by the parameter generation unit.

10. The computer readable storage medium having recorded thereon the computer program according to claim 9, wherein the program further controls the computer so that
the first determination unit determines whether first absolute position data are acquired at timings of both ends of the first positioning period,
the second determination unit determines whether second absolute position data are acquired at timings of both ends of the second positioning period,
the route data correction unit further includes:
a first correction unit that performs a similarity transformation by uniformly expanding or contracting and rotating a first locus corresponding the first part of the series of route data, such that both end positions of the first locus match the respective first absolute position data when the first determination unit determines that the first absolute position data are acquired, and
a second correction unit that performs a similarity transformation by uniformly expanding or contracting and rotating a second locus corresponding the second part of the series of route data, such that both end positions of the second locus match the respective second absolute position data when the second determination unit determines that the second absolute position data are acquired,
wherein the parameter generation unit generates an expansion/contraction ratio and a rotation angle to be used in the similarity transformation performed by the second correction unit, as the correction parameter, and
the parameter correction unit corrects the first part of the series of route data based on the correction parameter generated by the parameter generation unit.

11. The computer readable storage medium having recorded thereon the computer program according to claim 10, wherein the program further controls the computer so that
the first determination unit determines whether absolute position data are acquired at three or more timings including the timings of the both ends of the first positioning period, and wherein
when the first determination unit determines that the absolute position data are acquired at three or more timings including the timings of the both ends of the first positioning period, the first correction unit determines at least one of the expansion/contraction ratio and the rotation angle to be used in the similarity transformation based on a predetermined condition so as to decrease a difference between each of the absolute position data acquired at the three or more timings and each corresponding position data in the series of route data after the similarity transformation.

12. The computer readable storage medium having recorded thereon the computer program according to claim 11, wherein the program further controls the computer so that the first correction unit determines at least one of the expansion/contraction ratio and the rotation angle to be used in the similarity transformation so as to minimize a mean square error between the absolute position data acquired at the three or more timings and the corresponding position data in the series of data after the similarity transformation.
